(19) United States
(12) Patent Application Publication
(10) Pub. No.: US 2025/0014372 A1
(43) Pub. Date: Jan. 9, 2025

(54) INFORMATION PROCESSING APPARATUS, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: YOHEI OKATANI, Kanagawa (JP)

(21) Appl. No.: 18/759,732

(22) Filed: Jun. 28, 2024

(30) Foreign Application Priority Data
Jul. 4, 2023 (JP) 2023-109879

(51) Int. Cl. G06V 30/148; G06F 3/04845; G06F 40/295; G06V 30/19; G06V 30/262

(52) U.S. Cl. CPC G06V 30/153; G06F 3/04845; G06F 40/295; G06V 30/19093; G06V 30/262

(57) ABSTRACT

An information processing apparatus includes: at least one memory that stores instructions; and at least one processor that executes the instructions to: extract a character string and a unit character included in the character string based on a result of character recognition processing on a document image; generate context information related to the unit character based on the extracted character string and attribute information indicating an attribute of the character string; and display the extracted unit character and the context information corresponding to the unit character on a UI screen.

### BACKGROUND OF THE INVENTION

### Field of the Invention

The present disclosure relates to a technique of efficiently performing a confirmation operation of a recognition result for each character.

### Description of the Related Art

There has been known a character recognition technique to extract a character from an image including the character, and the technique is applied to various technical fields. In character recognition processing, a recognition error of the character occurs; for this reason, a confirmation operation and a proofreading operation are manually performed on an extracted result. These operations generally require time, and it is a burden on a worker. In order to solve this problem, there has been proposed a UI to efficiently perform the confirmation operation. Japanese Patent Laid-Open No. 2013-073608 discloses a method of listing and displaying plural character images having the same character recognition results (in the same cluster) to allow a user to confirm the images visually. That is, only character image portions having the same character recognition results are cut out, and the plural images of single character that are cut out are listed and displayed to allow the user to confirm the character subjected to the character recognition processing.

### SUMMARY OF THE INVENTION

An information processing apparatus according to the present disclosure includes: at least one memory that stores instructions; and at least one processor that executes the instructions to: extract a character string and a unit character included in the character string based on a result of character recognition processing on a document image; generate context information related to the unit character based on the extracted character string and attribute information indicating an attribute of the character string; and display the extracted unit character and the context information corresponding to the unit character on a UI screen.

Further features of the present disclosure will become apparent from the following description of exemplary embodiments with reference to the attached drawings.

### BRIEF DESCRIPTION OF THE DRAWINGS

FIG. 1 is a diagram illustrating a configuration example of an image processing system;

FIG. 2 is a diagram illustrating a hardware configuration example of an image processing server included in the present system;

FIG. 3 is a diagram illustrating a software configuration example of the image processing server included in the present system;

FIG. 4 is a flowchart explaining overall processing executed by the image processing server;

FIG. 5 is a flowchart explaining image processing job generation processing executed by the image processing server;

FIG. 6 is a diagram illustrating a configuration of character string region information;

FIG. 7 is a diagram illustrating a configuration of context information;

FIG. 8 is a flowchart explaining screen generation processing executed by the image processing server;

FIGS. 9A, 9B, and 9C are diagrams illustrating screen configuration examples that list and display character recognition results;

FIGS. 10A, 10B, 10C, and 10D are flowcharts explaining various types of screen generation processing executed by the image processing server;

FIG. 11 is a diagram illustrating a screen configuration example that superimposes and displays the context information on an image;

FIGS. 12A and 12B are diagrams illustrating screen configuration examples that superimpose and display an identical/similar recognition result on the image;

FIGS. 13A and 13B are diagrams illustrating screen configuration examples that list and display similar recognition results;

FIGS. 14A and 14B are flowcharts explaining the image processing job generation processing and the screen generation processing executed by the image processing server;

FIG. 15 is a diagram illustrating a screen configuration example that superimposes and displays the context information and a certainty factor on the image;

FIG. 16 is a flowchart explaining the screen generation processing executed by the image processing server;

FIGS. 17A, 17B, and 17C are flowcharts explaining image formation processing, the image processing job generation processing, and the screen generation processing executed by the image processing system; and

FIGS. 18A and 18B are diagrams illustrating screen configuration examples that display the identical/similar recognition results.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically. In addition, the same components are denoted by the same reference numerals. Further, each process (step) in the flowcharts and the sequence charts is denoted by a reference numeral starting with S.

### First Embodiment

### <Overall Configuration>

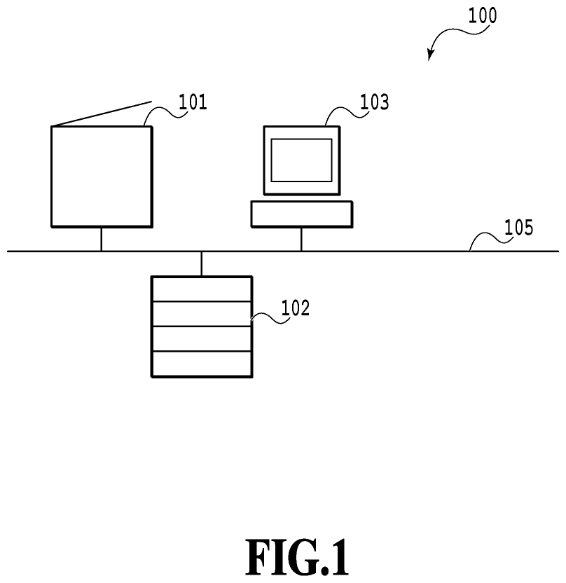

FIG. 1 is a diagram illustrating an example of a configuration of an image processing system 100 in the present embodiment. The image processing system 100 includes an image formation apparatus 101, an image processing server 102 (an information processing apparatus 102), and an information processing terminal 103. These apparatuses and servers are connected to each other by a network 105 and can communicate with each other. The image formation apparatus 101 has a function to obtain business form image data (a document image) by optically reading a paper document business form and transmit the data to the image processing server 102 through the network 105. An example of the paper document business form may include various types of business forms including plural items such as money amount and date and time like a bill or a receipt. In these business forms, a handwritten character, a printed character, and the like are put for each of the above-described plural items.

The image processing server 102 is communicably connected with the image formation apparatus 101 and the information processing terminal 103 through the network 105. As an example of the network 105, the Internet, a local area network (LAN), Wi-Fi (registered trademark), and the like are applied. As an example of the image processing server 102, a general-purpose computer such as a server computer and a personal computer is applied.

The information processing terminal 103 is an apparatus operated by a worker who performs a confirmation operation. In the information processing terminal 103, an application to be operated by the worker is installed, and a user interface (UI) screen for the confirmation operation is displayed. The confirmation operation includes an operation to confirm a recognition result of a character and the like included in a business form image and an operation to correct the character recognition result. As an example of the information processing terminal 103, a general-purpose computer such as a personal computer, a portable terminal device such as a smartphone and a tablet terminal, and the like are applied.

### <Hardware Configuration>

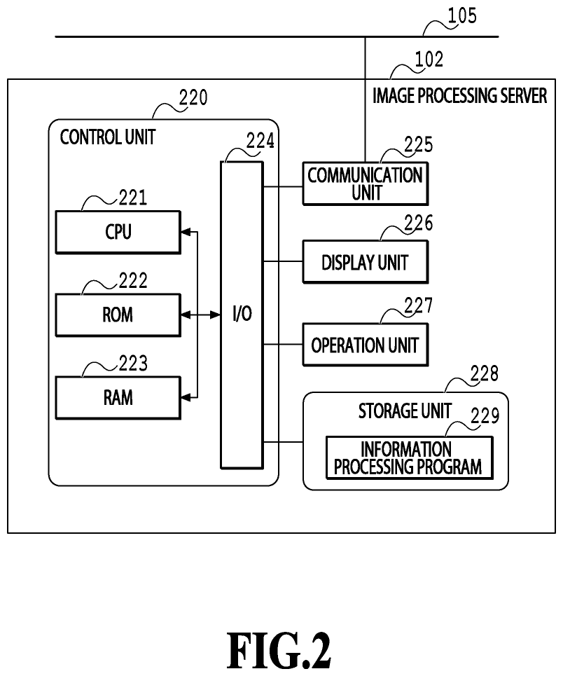

FIG. 2 is a diagram illustrating an example of a hardware configuration of the image processing system 100 in the present embodiment. As illustrated in FIG. 2, the image processing server 102 includes a control unit 220, a communication unit 225, a display unit 226, an operation unit 227, and a storage unit 228. The control unit 220 includes a CPU 221, a ROM 222, a RAM 223, and an input and output interface (I/O) 224, and these units are connected with each other through a bus.

The CPU 221 reads out a program and data stored in the ROM 222 and the storage unit 228 to the RAM 223 and executes various types of processing described later. The ROM 222 stores fixed data such as the program and the data executed by the CPU 221. The RAM 223 is used as a main memory of the CPU 221 and a temporary storage region such as a working area. The I/O 224 is connected to the communication unit 225, the display unit 226, the operation unit 227, and the storage unit 228. These functional units are mutually communicable with the CPU 221 through the I/O 224.

As an example of the display unit 226, a liquid crystal display (LCD), an organic electro luminescence (EL) display, and the like are used. As an example of the operation unit 227, a device for operation input such as a keyboard and a mouse are used. In the above descriptions, the display unit 226 and the operation unit 227 are separated bodies; however, it is not limited thereto. The display unit 226 and the operation unit 227 may be integral with each other by using a touch panel, for example. Additionally, the CPU 221 receives various types of instructions to the image processing server 102 from the user through the operation unit 227. The display unit 226 displays various types of information such as a result of processing executed in response to the instruction received from the user and a notification for the processing. As an example of the storage unit 228, a hard disk drive (HDD), a solid state drive (SDS), a flash memory, and the like are used. The storage unit 228 stores an information processing program 229 and the like.

### <Software Configuration>

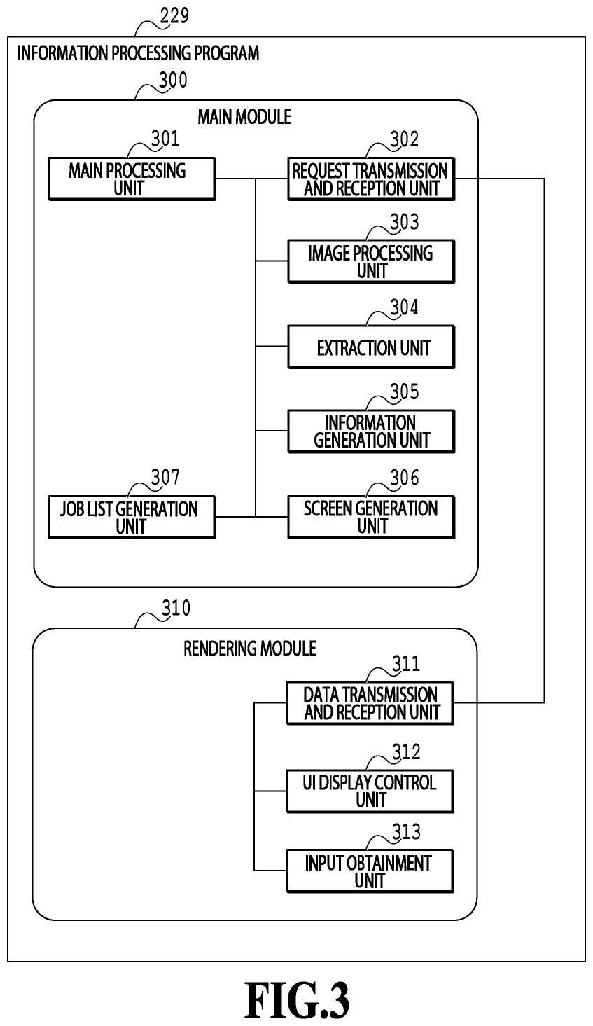

FIG. 3 is a diagram illustrating an example of a software configuration of the image processing system 100 in the present embodiment. As illustrated in FIG. 3, the information processing program 229 includes a main module 300 and a rendering module 310. The main module 300 includes a main processing unit 301, a request transmission and reception unit 302, an image processing unit 303, an extraction unit 304, an information generation unit 305, a screen generation unit 306, and a job list generation unit 307. The rendering module 310 includes a data transmission and reception unit 311, a UI display control unit 312, and an input obtainment unit 313. The information processing program 229 is read by the RAM 223 and executed by the CPU 221.

The main module 300 is executed by the CPU 221 and executes processing to extract information by processing an image according to a request, processing to generate a screen displayed on a UI based on the extracted information, and the like. Here, the main module 300 saves the generated information and the like in the storage unit 228; however, for example, the generated information and the like may be saved in another information processing apparatus such as the information processing terminal 103 through the network 105. The main module 300 receives an event from the operation unit 227 and the rendering module 310; however, for example, the event may be received from another information processing apparatus such as the information processing terminal 103 through the network 105.

The main processing unit 301 controls overall processing of the main module 300 and makes a request to the units included in the main module 300 to perform processing. The request transmission and reception unit 302 transmits a request from the main module 300 to the rendering module 310 and receives a request from the rendering module 310. The image processing unit 303 performs image processing such as binarization of the document image. The extraction unit 304 extracts a character string (a specific character string) and a rectangular region (a specific character string region) including the character string by performing block selection (BS) and optical character recognition (OCR) within the document image. The extraction unit 304 also extracts a single character (a unit character) and a rectangular region (a unit character region) including each single character by cutting out the characters one by one in the character string region. Additionally, the extraction unit 304 also extracts a certainty factor of character recognition of each single character. In addition, in a case where there is information including an identification number to identify a person name and a person in the extracted character string, the extraction unit 304 also extracts the information. The information generation unit 305 generates attribute information indicating the extracted character string and context information of each extracted single character. The screen generation unit 306 generates a screen to confirm the character recognition result based on the extracted character string and the generated context information. The job list generation unit 307 generates a unit of processing for the character recognition result confirmed on the UI screen by the user as a job and generates a job list storing all the jobs.

The rendering module 310 is executed by the CPU 221 and executes processing to display a received screen and processing to receive the inputted event from the user and transmit the event as the request. Here, the rendering module 310 displays the received screen on the display unit 226; however, for example, the received screen may be displayed on a display unit of another information processing apparatus such as a display unit of the information processing terminal 103 through the network 105.

The data transmission and reception unit 311 receives the screen generated by the screen generation unit 306 and transmits a processing request to the main module 300. The UI display control unit 312 receives the screen generated by the screen generation unit 306 through the data transmission and reception unit 311 and displays the received UI screen on the display unit 226. The input obtainment unit 313 receives a user input on the UI screen. Additionally, the input obtainment unit 313 transmits the processing request for the event that occurs with the user pressing the UI screen to the main module 300 through the data transmission and reception unit 311.

### <Overall Processing Flow>

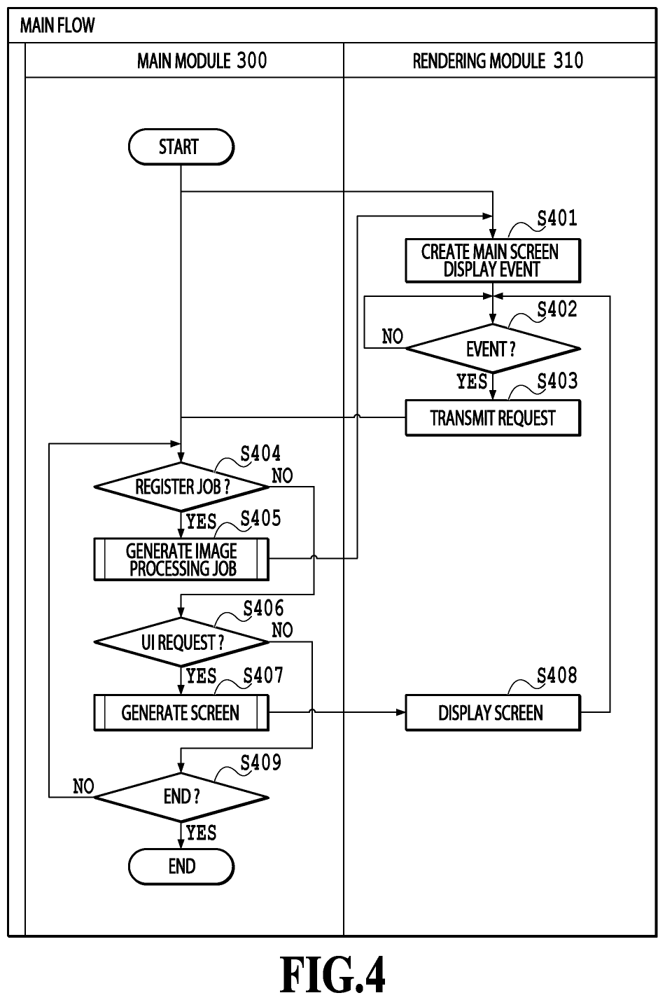

FIG. 4 is a flowchart illustrating details of processing to display a confirmation UI of the character recognition result executed by the information processing program 229. In the present display processing, the processing is executed by the mutual communication between the main module 300 and the rendering module 310. Additionally, the main module 300 and the rendering module 310 are executed by the CPU 221 of the image processing server 102.

In S401, the CPU 221 generates an event to create a main screen of the confirmation UI of the character recognition result, and the processing proceeds to S402. In S402, the CPU 221 waits for occurrence of the event. Here, the event is an input from the user through the operation unit 227, for example. In a case where the event occurs (in a case where S402 is YES), the processing proceeds to S403. In a case where the event does not occur (in a case where S402 is NO), the processing returns to S402 and waits for occurrence of the event. In S403, the CPU 221 creates the processing request according to the event that occurs in S402 and transmits the request to the main module 300 through the data transmission and reception unit 311. In a case where the request is transmitted to the main module 300, the processing proceeds to S404. Here, the processing request is a request for processing to generate a screen that filters and displays the character recognition result, for example. In a case of transmitting the request to the main module 300, an image may be attached to the request. In the present embodiment, the attached image is obtained from the image formation apparatus 101; however, it is not limited thereto. Another obtainment method such as uploading by way of the rendering module 310 or obtaining from an online storage may be applied. Additionally, information indicating a storage place of the image such as a URL of the image may be attached to the request, and someone who receives the request may obtain the image from the place of the image.

In S404, the CPU 221 determines whether the type of the request received through the request transmission and reception unit 302 is a request to generate the job, which is the unit of processing that requires the recognition result confirmation by performing the image processing, and to register the generated job with the job list. The request is a request to generate the screen that is created in S403 or a request to generate the job by performing the image processing, for example. In a case where the type of the request is the job registration (in a case where S404 is YES), the processing proceeds to S405. In a case where the type of the request is not the job registration (in a case where S404 is NO), the processing proceeds to S406. In S405, the CPU 221 performs the character recognition processing on the image, generates the job, which is the unit of processing that requires confirmation of the character recognition result, and registers the generated job with the job list. In a case where the job is registered with the job list, the processing returns to S401.

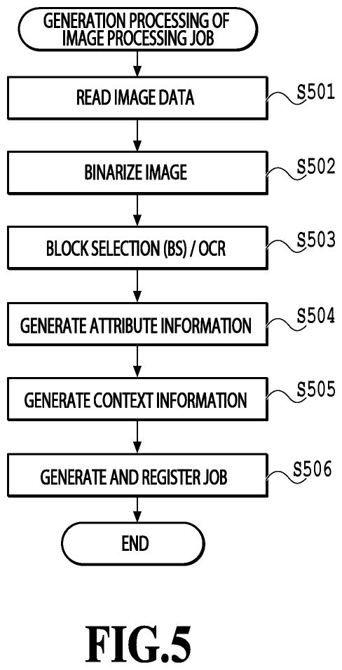

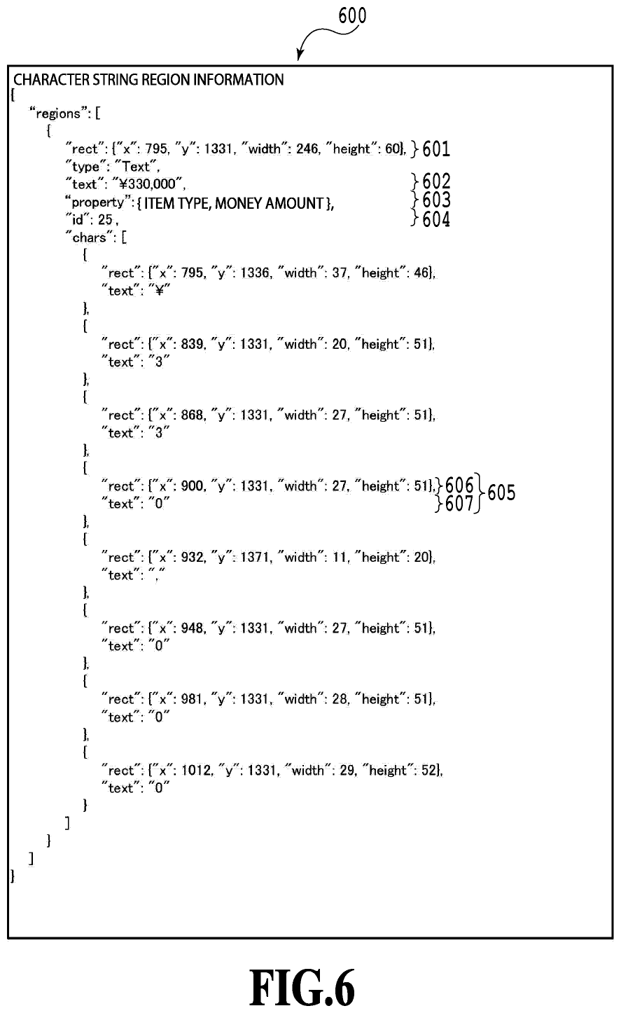

FIG. 5 is a flowchart describing a detailed procedure of the processing in S405 in the present embodiment. The present flowchart is executed by the main module 300. First, in S501, the CPU 221 obtains image data included in the request, and the processing proceeds to S502. In S502, the CPU 221 binarizes the image obtained in S501 and generates a binarized image, and the processing proceeds to S503. Here, the binarization of the image is processing to convert a color image into two values that are, for example, black and white, and a publicly known method is used as the conversion method. In S503, the CPU 221 executes BS and OCR on the binarized image generated in S502, and the processing proceeds to S504. Here, block selection indicates processing to extract the rectangular region indicating the place of the character string from the image. OCR indicates processing to extract the character string from the image. In the present embodiment, in a case where the CPU 221 executes BS and OCR, character string region information 600 illustrated in FIG. 6 is generated.

FIG. 6 is an example of character string region information and formed in the JavaScript Object Notation (JSON) format. Description of the JSON format is omitted. In the present embodiment, the character string region information is formed in the JSON format; however, the character string region information may be formed in another format such as Extensible Markup Language (XML) and Comma-Separated Values (CSV).

The character string region information 600 holds information on one or more character string regions. The character string region information 600 includes rectangle information 601, a character string region type, a character string 602, single character region information, attribute information 603, and an identification number 604. The rectangle information 601 includes top left coordinates, a width, and a height of the rectangle of the character string region. The character string 602 is a character string extracted by OCR. The attribute information 603 is additional information describing the character string described later. The identification number 604 is a unique number allocated to the character string region. Single character region information 605 includes rectangle information 606 and a character 607 of the single character. Although the present embodiment has the above-described configuration, other information may be included.

In S504, the CPU 221 executes attribute information recognition by using the character string region information 600 generated in S503 and generates the attribute information 603 describing the character string region. In a case where the attribute information 603 is generated, the processing proceeds to S505. In S504, the attribute information indicated by the character string is extracted by natural language processing using artificial intelligence (AI). For example, in a case where the character string region is a character string region indicating a money amount, which is “¥330,000”, indicated in the character string 602, the CPU 221 applies the attribute information “item type: money amount” indicated in the attribute information 603.

In addition, in a case where the character string regions have a relationship of a pair of the item name and the item value, the character strings are associated with each other as a key-value relationship. Here, the key-value relationship is extracted as the attribute information if the character string by a method using a layout relationship of the image and a rule-based system. For example, in a case where there is the character string “¥330,000” on the right side of the character string “amount billed” on the image, the attribute information is applied according to the two character strings as the key-value. In addition, in a case where there is the character string indicating the type of the image in the extracted character string, the CPU 221 applies the attribute information indicating the type of the image. Here, the attribute information indicated by the character string is extracted also by the natural language processing using the AI. For example, in a case where there is the character string “bill”, the CPU 221 assigns the attribute information “business form type: bill” as the type of the image. Additionally, the attribute information may be provided in advance by an input from the user. Moreover, the attribute information is not limited to the above.

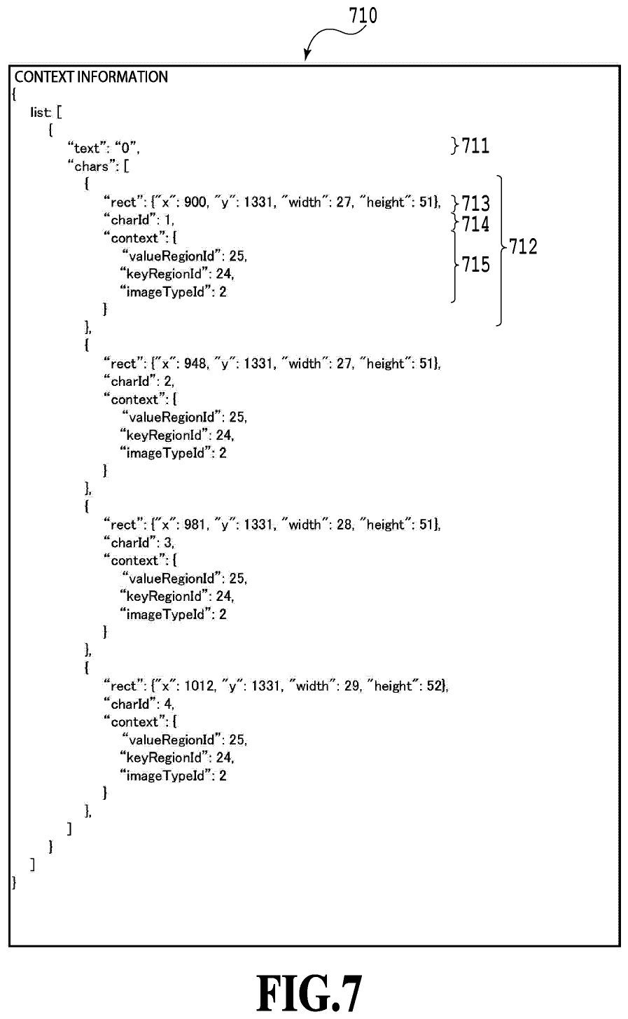

In S505, the CPU 221 generates context information 710 by using the character string region information 600 generated in S503 and the attribute information 603 generated in S504. In a case where the context information 710 is generated and saved, the processing proceeds to S506. FIG. 7 is a diagram illustrating an example of the context information 710. First, the CPU 221 obtains the single character region information from the character string region information 600, groups the information by character, and stores the information in the list for each character group. Here, a publicly known method is used as the grouping method. The character group that is each element of the list is formed of a list of recognized character types and the single character regions of the group. For example, a recognized character 711 indicates that a recognition result of the single character region of the character group is “0”. The single character region that is recognized as “0” and indicated by information 712 is stored in the list. Each single character region includes rectangle information 713, an identification number 714, and context information 715. As illustrated in FIG. 7, the rectangle information 713 is information that includes top left coordinates, a width, and a height of the rectangle of the single character region and is obtained from the rectangle information 606. As illustrated in FIG. 7, the identification number 714 allocates a unique number to the single character region. In the present embodiment, the context information 715 includes information below. The first information is the attribute information of the character string including the single character region and information on the image region corresponding to the character string including the single character region. The second information is the attribute information of an adjacent character string having the key-value relationship with the above character string and information on the image region corresponding to the adjacent character string. The third information is the attribute information of the character string indicating a type of the document image and information on the image region of the character string indicating the type of the document image. Note that, the context information 715 is not limited to the above-described information.

In the present embodiment, as illustrated in FIG. 7, the context information 715 holds the identification number of the character string region in “valueRegionId”, and it is possible to obtain the character string region and the attribute information through reverse lookup using the identification number 604. In addition, the CPU 221 saves the generated character string region information 600 and context information 715 in the storage unit 228.

In S506, the CPU 221 generates the job, which is the unit of processing that requires confirmation of the character recognition result by the user. One image obtained in S501, one piece of character string region information generated in S503, and one piece of context information generated in S505 are associated with each job. In addition, the generated job is inserted into the job list. Table 1 is an example of the job list. An identification number is applied to the image information, the character string region information, and the context information, and the information is saved in the storage unit 228. Each identification number is registered with the job list, and the job and the image, the character string region information, and the context information are associated with each other. In a case where the job is generated, the CPU 221 registers the generated job with the job list, and the processing of the flowchart illustrated in FIG. 5 ends.

TABLE 1

| job | | character string region | |
|---|---|---|---|
| ID | image information | information | context information |
| 1 | image information 1 | character string region | context information |
| | | information 1 | 1 |
| 2 | image information 2 | character string region | context information |
| | | information 2 | 2 |

Return to the explanation of FIG. 4. In S406, the CPU 221 determines whether the type of the received request is the request for the UI. In a case where the type of the request is the UI request (in a case where S406 is YES), the processing proceeds to S407. In a case where the type of the request is not the UI request (in a case where S406 is NO), the processing proceeds to S409. In S407, the CPU 221 (the main module 300) generates the screen to be operated by the user according to the contents of the request.

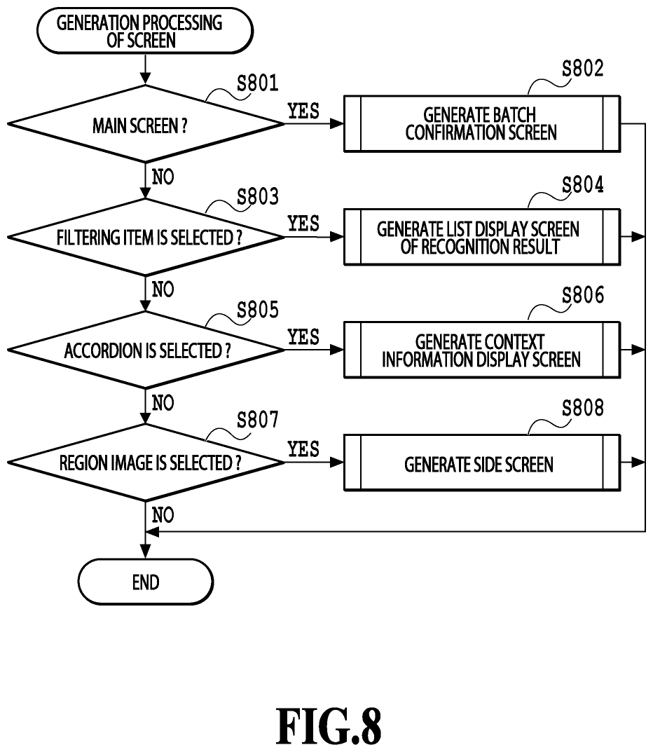

FIG. 8 is a flowchart explaining a detailed procedure of the processing in S407 in the present embodiment. The present flowchart is executed by the main module 300. First, in S801, the CPU 221 determines whether the received type of the request is a main screen generation request. The main screen generation request is the request generated in S401 and is a request to generate the main screen displayed by default in a case where the UI of the present embodiment is activated.

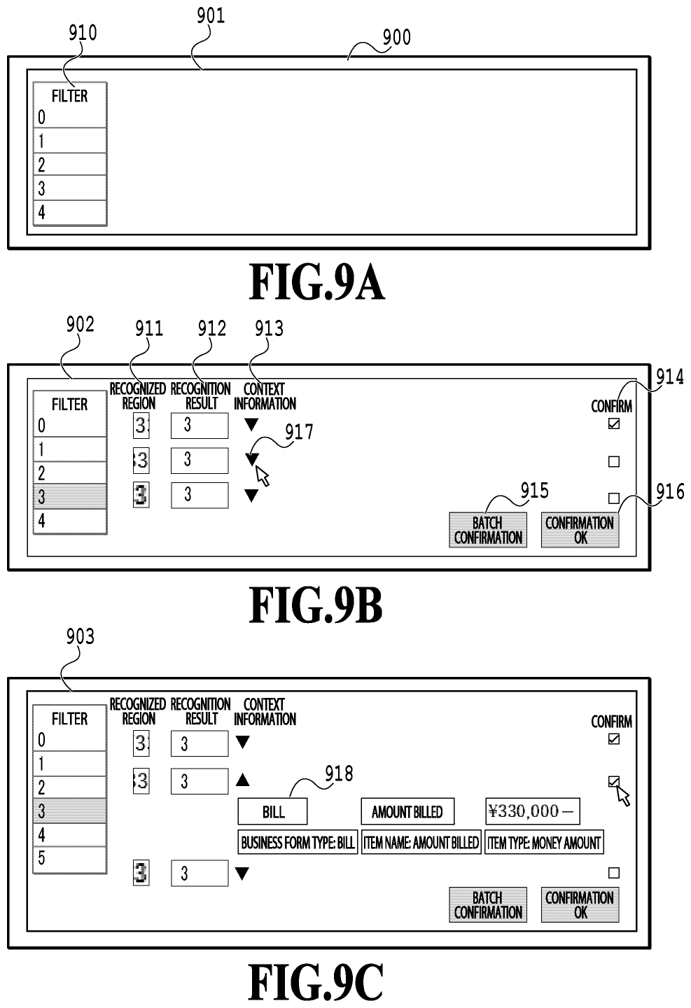

In a case where the type of the request is to generate the main screen (in a case where S801 is YES), the processing proceeds to S802. In a case where the type of the request is not the main screen generation (in a case where S801 is NO), the processing proceeds to S803. In S802, the CPU 221 (the main module 300) executes generation of a batch confirmation screen. An example of the batch confirmation screen to be generated is illustrated in FIG. 9A. In the example in FIG. 9A, a batch confirmation screen 900 includes a recognition result filtering screen 901. In a case where the user selects a filtering item while the batch confirmation screen 900 is being displayed, a screen illustrated in FIG. 9B is displayed. The screen can display a list of the recognition results of OCR for each character, and it is possible to confirm whether the recognition result is correct or incorrect and proofread the recognition result.

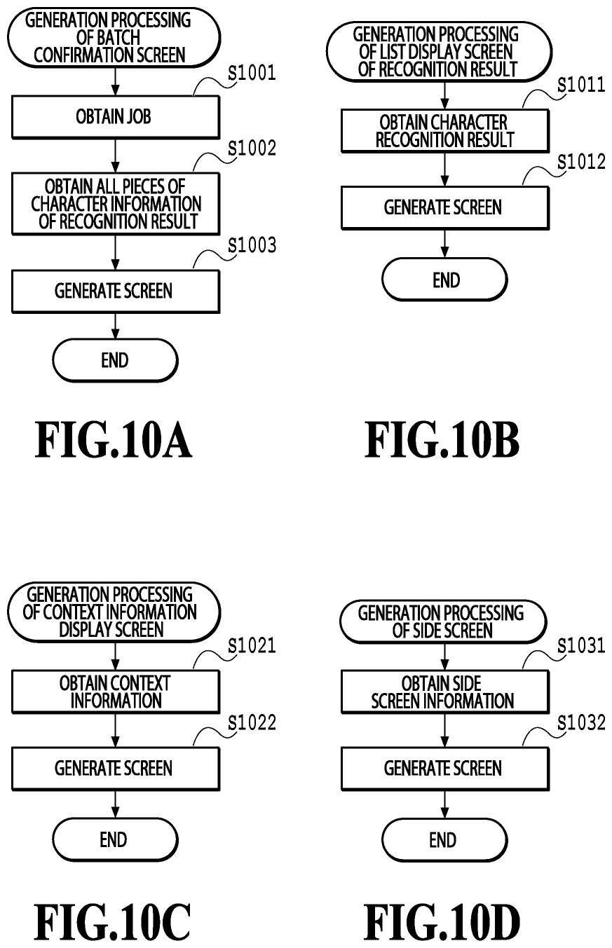

FIG. 10A is a flowchart describing a detailed procedure of the processing in S802 in the present embodiment. The present flowchart is executed by the main module 300. First, in S1001, the CPU 221 obtains the job list generated in S506. In addition, the CPU 221 obtains the job from the job list and obtains the context information 710 associated with the job. Here, all the jobs may be obtained from the job list, or the obtainment may be limited to the job associated with the user or a group to which the user belongs. In a case where the obtainment of the job and the context information 710 is completed, the processing proceeds to S1002. In S1002, the CPU 221 obtains the character types of all the recognition result characters from the obtained job based on the context information 710 obtained in S1001. To be more specific, the recognized character 711 of the character group is obtained for each element of the list. In a case where the character types of all the recognition result characters are obtained, the processing proceeds to S1003. In S1003, the CPU 221 generates the batch confirmation screen 900 including the recognition result filtering screen 901. In addition, the CPU 221 generates a recognition result filter 910 on the recognition result filtering screen 901 by using the character types of all the recognition result characters obtained in S1002. An example of the screen generated in this process is illustrated in the recognition result filtering screen 901 in FIG. 9A. The recognition result filtering screen 901 allows the user to filter and display the character recognition result by using any character by the recognition result filter 910. Additionally, the recognition result filter 910 sorts and displays the character types of all the recognition result characters obtained in S1002. In this case, a publicly known method is used as the sorting method. In the present embodiment, the character types are sorted in numerical order; however, it is not limited thereto. For example, the character types may be sorted in ascending order of character codes. In a case where the batch confirmation screen 900 and the recognition result filtering screen 901 are generated, the processing of the flowchart illustrated in FIG. 10A ends.

Return to the explanation of FIG. 8. In S803, the CPU 221 determines whether the received request is to select the filtering item by the user. Here, the request to select the filtering item is a request transmitted in S403 according to the event that occurs in a case where the user presses an arbitrary item of the recognition result filter 910. In a case where the request is to select the filtering item by the user (in a case where S803 is YES), the processing proceeds to S804. In a case where it is not the request to select the filtering item by the user (in a case where S803 is NO), the processing proceeds to S805. In S804, the CPU 221 executes generation of a list display screen of the recognition result.

FIG. 10B is a flowchart explaining a detailed procedure of the processing in S804 in the present embodiment. The present flowchart is executed by the main module 300. First, in S1011, the CPU 221 obtains the filtering item selected by the user. In addition, the CPU 221 obtains from the obtained job all the pieces of single character information that have the same recognition result as the character of the filtering item selected by the user. To be more specific, all the character groups that fall under the character of the filtering item selected by the user are obtained from the context information 710 of all the obtained jobs. In a case where the obtainment of the character recognition result is completed, the processing proceeds to S1012. In S1012, the CPU 221 generates a screen to display the single character information obtained in S1011.

A screen 902 illustrated in FIG. 9B is an example of the screen to be displayed. The screen 902 displays a region image 911, a recognition result 912, context information 913, a confirmation checkbox 914, a batch confirmation button 915, and a confirmation OK button 916 and receives confirmation and proofreading of the recognition result by the user. The region image 911 displays the single character region obtained in S1011 in the list. To be more specific, the rectangular region on the image is cut out by using the rectangle information of the single character region and displayed. The recognition result 912 displays the character recognition result of the region image 911 and receives proofreading by the user. The context information 913 displays context information associated with the region image 911. The context information is hidden by default, and the context information is displayed with the user pressing an accordion unit 917 described later. The confirmation checkbox 914 receives whether the user is done with checking whether the recognition result of the region image 911 is correct or incorrect, proofreading, and confirmation of the item. In a case where the batch confirmation button 915 receives pressing by the user, all the items of the confirmation checkbox 914 are checked. In a case where the confirmation OK button 916 receives pressing by the user, the proofread recognition result is saved, and the confirmation operation by the user ends. In a case where the screen to display the single character information is generated, the processing of the flowchart illustrated in FIG. 10B ends.

Return to the explanation of FIG. 8. In S805, the CPU 221 determines whether the received request is to select an accordion by the user. Here, the request to select the accordion is a request transmitted in S403 according to the event that occurs in a case where the user presses the accordion unit 917 of any item of the context information 913. In a case where the request is to select the accordion by the user (in a case where S805 is YES), the processing proceeds to S806. In a case where the request is not to select the accordion by the user (in a case where S805 is NO), the processing proceeds to S807. In S806, the CPU 221 executes generation of a context information display screen.

FIG. 10C is a flowchart explaining a detailed procedure of the processing in S806 in the present embodiment. The present flowchart is executed by the main module 300. First, in S1021, the CPU 221 obtains the context information of the single character region selected by the user, and the processing proceeds to S1022. In S1022, the CPU 221 generates the screen to display the context information obtained in S1021. A screen 903 illustrated in FIG. 9C is an example of the screen to be displayed. In the screen 903, in a case where the accordion unit 917 receives pressing by the user, the screen is updated. The screen 903 displays context information 918 associated with the single character region selected by the user. In a case where the accordion unit 917 receives pressing by the user while the accordion already opens, the accordion is closed, and the corresponding context information is hidden.

Return to the explanation of FIG. 8. In S807, the CPU 221 determines whether the request received in the main processing unit 301 is to select the region image by the user. Here, the request to select the region image is a request transmitted in S403 according to the event that occurs in a case where the user presses an image of any item of the region image 911. In a case where the request is to select the region image by the user (in a case where S807 is YES), the processing proceeds to S808. In a case where the request is not to select the region image by the user (in a case where S807 is NO), the processing of the flowchart illustrated in FIG. 8 ends. In S808, the CPU 221 executes generation of a side screen.

FIG. 10D is a flowchart explaining a detailed procedure of the processing in S808 in the present embodiment. In the present flowchart, a business form context information screen, an identical/similar character comparison screen, or a similar character list screen is generated as the side screen (a detail screen). The business form context information screen, the identical/similar character comparison screen, and the similar character list screen can be switched to each other in response to an input from the user. For example, the screens are switched by using a tab; however, the switching method may be another method. In the present embodiment, an initial display is the business form context information screen.

In S1031, the CPU 221 obtains the image including the single character region selected by the user and the context information or the identical/similar character information associated with the single character region. In the obtainment of the identical character information, the single character region information of the character group falling under an identical character of the character selected by the user from the list of the character group included in the context information is obtained. In the obtainment of the similar character information, a similar character of the character selected by the user is obtained with reference to a similar character dictionary. Table 2 is an example of the similar character dictionary used to obtain the similar character. The similar character is a character that is likely to be recognized falsely as the target character in OCR processing. The CPU 221 stores in advance a dictionary of a pair of the target character and the similar character. For example, in Table 2, “D”, “O”, “Q” are the similar characters for the character “0”. In addition, the similar character dictionary may collect statistics information of the characters proofread by the user, and a pair of the target character and the similar character may be added thereto. The CPU 221 obtains the single character region information of the character group falling under the similar character from the list of the character group included in the context information. In a case where the context information or the identical/similar character information is obtained, the processing proceeds to S1032. In S1032, the CPU 221 generates the side screen by using the image and the context information or the identical/similar character information obtained in S1031.

TABLE 2

| target character | similar character |
|---|---|
| 0 | D, O, Q |
| 1 | !, J, I |
| 7 | 1, l, I |

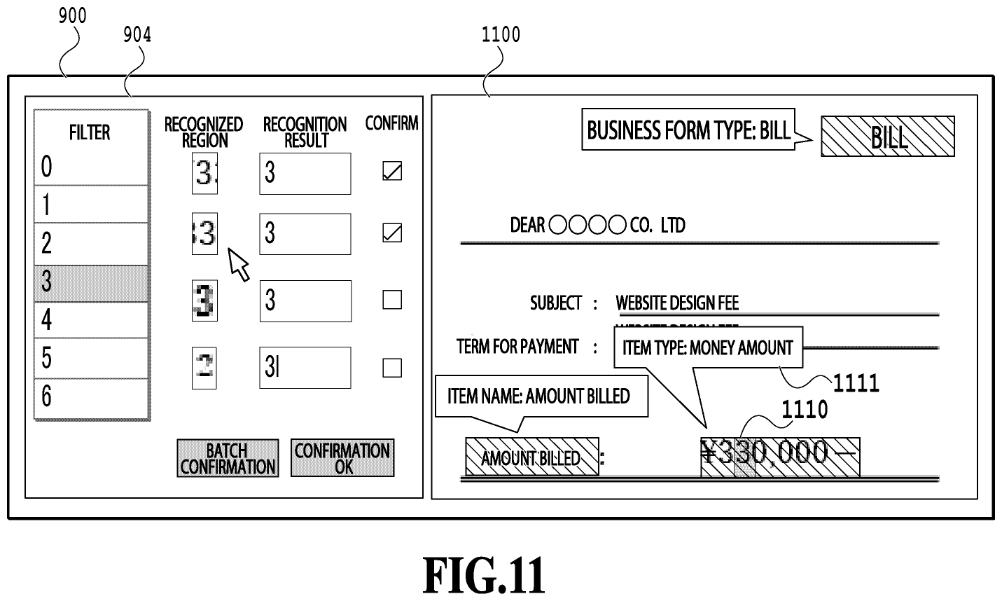

FIG. 11 is a diagram illustrating an example of the batch confirmation screen generated by the CPU 221 in S1032. In the present screen, it is possible to superimpose and display the context information of the single character region selected by the user on the image, and it is possible to confirm whether the recognition result is correct or incorrect or to proofread the recognition result by the user. The batch confirmation screen 900 in FIG. 11 includes a recognition result filtering screen 904 and a business form context information screen 1100. In the displaying of the recognition result filtering screen 904, the batch confirmation screen 900 receives the selection of the single character region image that the user feels it is difficult to determine, deletes the displayed context information 913, and displays the recognition result filtering screen 904 reduced in size on a left side of the screen. In this process, the batch confirmation screen 900 displays the business form context information screen 1100 on a right side of the screen.

The business form context information screen 1100 displays an image including the single character region selected by the user and the character string region of the context information associated with the single character region. In addition, the single character region and the character string region on the image are highlighted with colored frames, and the attribute information of the single character region and the character string region is displayed in a word balloon. A highlight 1110 highlights the single character region selected by the user and the character string region of the context information associated with the single character region with the colored frames on the image. In this process, the colors of the frames of the single character region selected by the user and the character string region of the context information are set to be different from each other. A word balloon 1111 displays the attribute information of the character string region indicated by the highlight 1110. In the present embodiment, the context information is the character string region including the single character region and the attribute information, the character string region having a relationship of key-value with the above character string region and the attribute information, and the character string region indicating the type of the image and the attribute information. Accordingly, in FIG. 11, the character strings “¥330,000-”, “amount billed”, and “bill” are highlighted, and the attribute information indicating the item type, the item name, and the business form type is displayed with word balloons, respectively. With this screen, it is possible to clearly show in what context the target character appears to the user and to facilitate the determination of the target character.

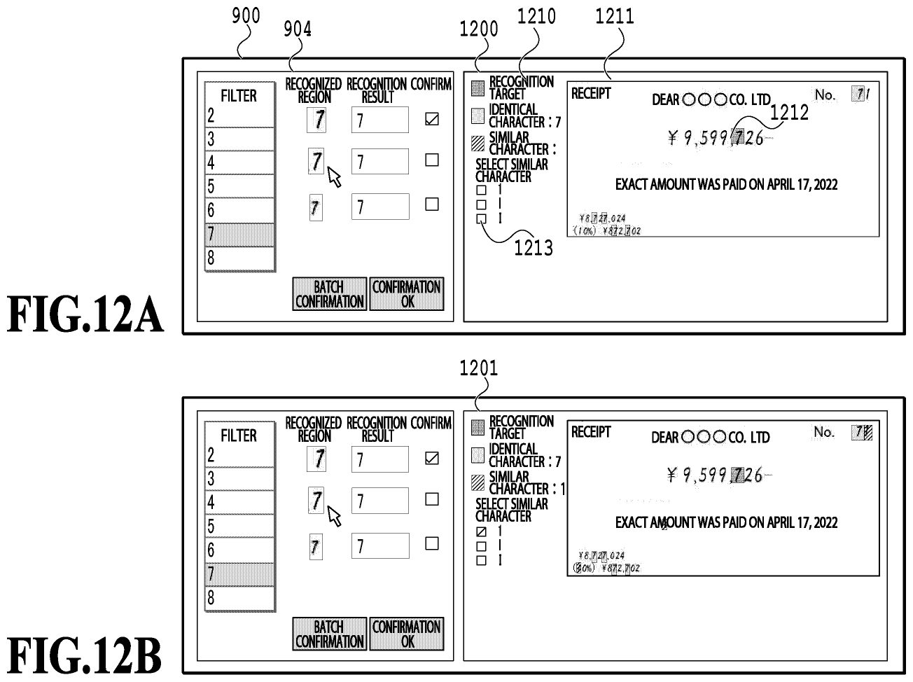

FIGS. 12A and 12B are diagrams illustrating an example of the batch confirmation screen generated by the CPU 221 in S1032. In the present screen, it is possible to highlight the identical character and the similar character of the single character region image selected by the user on a scanned image, and it is possible to confirm whether the recognition result is correct or incorrect or to proofread the recognition result. The batch confirmation screen 900 illustrated in FIG. 12A includes the recognition result filtering screen 904 and an identical/similar character comparison screen 1200.

The identical/similar character comparison screen 1200 highlights the identical/similar character on the image including the single character region selected by the user. A description 1210 displays legends of the colored frames in which the single character region selected by the user and the single character region of the identical/similar character are highlighted. A display image 1211 is an image including the single character region selected by the user and displays an image including the single character region and the single character region of the identical/similar character. A highlight 1212 highlights the single character region selected by the user and the single character region of the identical/similar character on the display image 1211 with the colored frames according to the descriptions of the description 1210. The single character region selected by the user and the single character region of the identical character are highlighted with the colored frames by default. In this case, the colors of the frames may be different from each other between the single character region selected by the user and the single character region of the identical character, or the colors may have the same hue but the transparency may be different. A checkbox 1213 allows for selecting of the similar character to be highlighted. In a case where the checkbox 1213 receives the selection by the user, the screen is updated to a screen 1201 (see FIG. 12B). The screen 1201 highlights the single character region of the similar character selected by the user with the colored frame on the image. In this case, the color of the frame of the single character region of the similar character is different from the single character region selected by the user and the single character region of the identical character. FIG. 12B illustrates an example in which the user selects “1” in the checkbox 1213 of the similar character. In FIG. 12B, “1” of “No. 71” and the like are highlighted as the similar character. With this screen, it is possible to facilitate the determination by the user of the character as the recognition target by comparing the identical character and the similar character with each other on the same image.

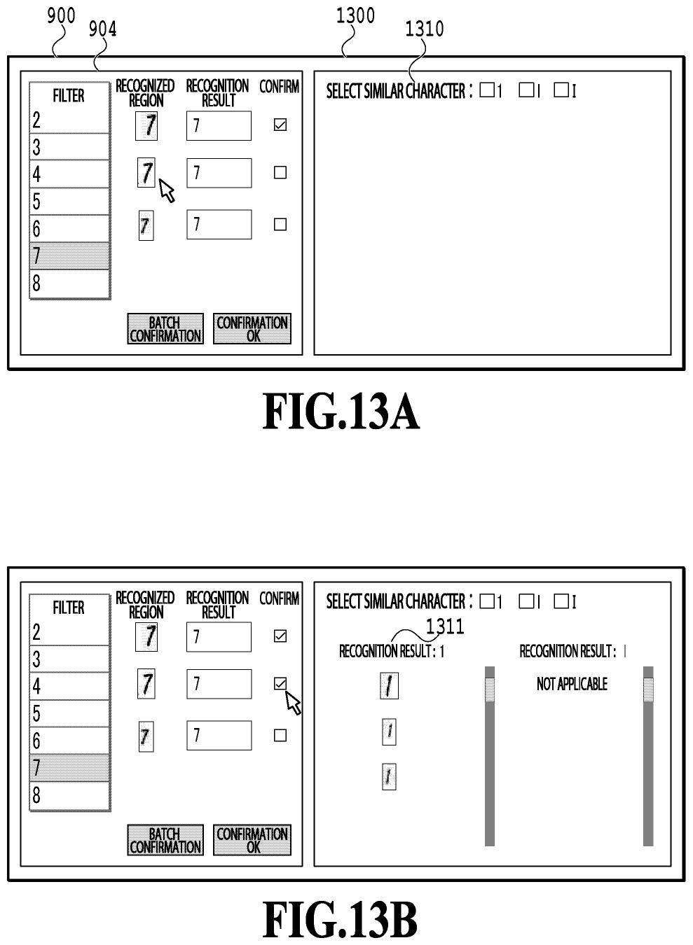

FIGS. 13A and 13B are diagrams illustrating an example of the batch confirmation screen generated by the CPU 221 in S1032. In the present screen, it is possible to list and display the single character region image selected by the user and the similar character, and it is possible to confirm whether the recognition result is correct or incorrect or to proofread the recognition result. In the example in FIG. 13A, the batch confirmation screen 900 includes the recognition result filtering screen 904 and a similar character list screen 1300.

The similar character list screen 1300 lists and displays the similar characters of the single character region selected by the user. A checkbox 1310 lists and displays the similar characters, and the user can select the similar character. In a case where the similar character list screen 1300 receives the selection from the user in the checkbox 1310, a similar character list 1311 is displayed (see FIG. 13B). The similar character list 1311 illustrated in FIG. 13B lists and displays the single character regions recognized as the similar character selected by the user. Since the character shapes depending on the font or the habit of a writer are similar to each other in the same image, the single character region of the similar character that is in the same job as the job including the single character region selected by the user is prioritized to be displayed on the top of the list. In this process, a line may be displayed on a boundary between the single character region of the similar character of the same job and the single character region of the similar character of a different job to clearly show the boundary, or the similar character other than the same job may not be displayed. With this screen, it is possible to facilitate the determination by the user on the recognition result of the target character by comparing the target character and the similar character with each other by listing and displaying the characters to the user.

In the present embodiment, the character types of the character string, the character, and the single character are not limited to a number, and Chinese character, hiragana, katakana, alphabet, sign, and other character types may be included. For example, the item type “address” may be associated as the context information of the single character region “c” of the character string having the recognition result “city” so as to be displayed to allow for the confirmation. Additionally, the similar character may include other character types or may be set to limit the character type to be used. For example, a number “1” or a sign “|” (a vertical bar) may be displayed as the similar character of the single character having the recognition result that is an alphabet “1”.

Return to the explanation of FIG. 4. In S408, the CPU 221 displays on the display unit 226 the screen that is generated in S407 and received through the data transmission and reception unit 311. In a case where the screen is displayed on the display unit 226, the processing returns to S402. In S409, the CPU 221 determines whether the type of the request is to end the program. In this case, the request to end the program is a request transmitted in S403 according to the event that occurs in a case where the user presses the confirmation OK button 916. Additionally, the request to end the program is generated also in another case such as a case of closing the UI or a case of transmission from another information processing apparatus. In a case where the type of the request is to end the program (in a case where S409 is YES), the processing of the flowchart illustrated in FIG. 4 ends. In a case where the type of the request is not to end the program (in a case where S409 is NO), the processing returns to S404 to wait for a request from the rendering module 310.

With the present disclosure being implemented by the above-described processing procedure, it is possible to display the information that helps the determination by the user in a case where the single character region image that the user feels it is difficult to determine is displayed during the confirmation operation of the character recognition result. Therefore, the time required for the determination by the user is shortened, and the usability during the confirmation operation of the character recognition result is improved.

### Second Embodiment

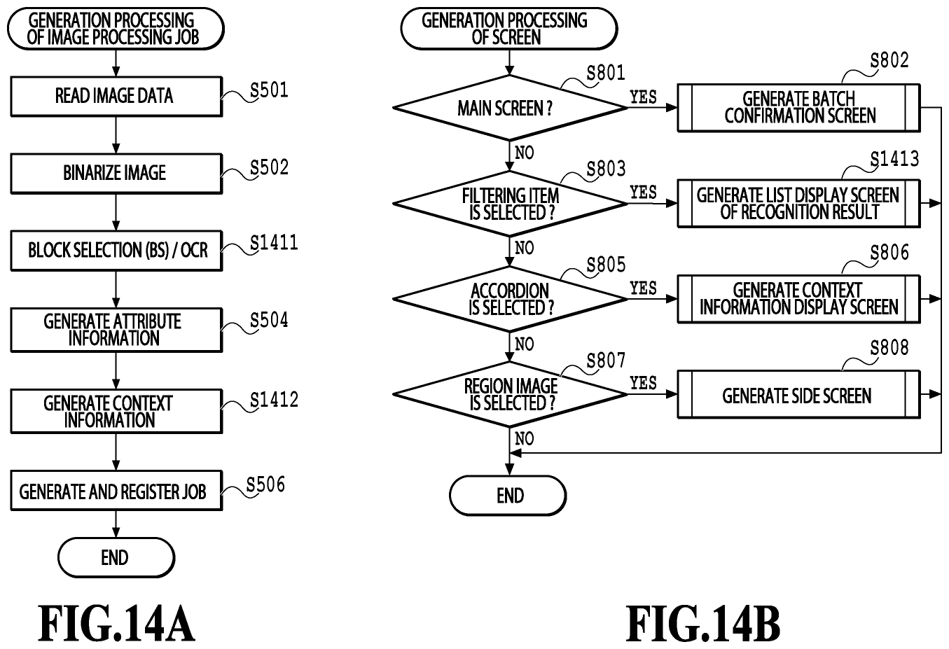

In the present embodiment, further improvement of the efficiency of the confirmation operation by the user by reducing the operation required to display the context information by the user based on a certainty factor of the character recognition result is specifically described with reference to the drawing and the flowchart. Note that, in the description of the present embodiment, description of a portion in which the configuration and the processing procedure are the same as that in the first embodiment is omitted, and only a portion having a different point is described. FIG. 14A is a flowchart describing a detailed procedure of the image processing job generation in the present embodiment. In the present embodiment, in S1411, the CPU 221 calculates the certainty factor of the character recognition for each character in a case of performing the character recognition in the BS/OCR processing. In addition, in S1412, the CPU 221 adds the certainty factor of each single character to the character string region information 600 and the context information 710 and saves the information in the storage unit 228 during the context information generation processing.

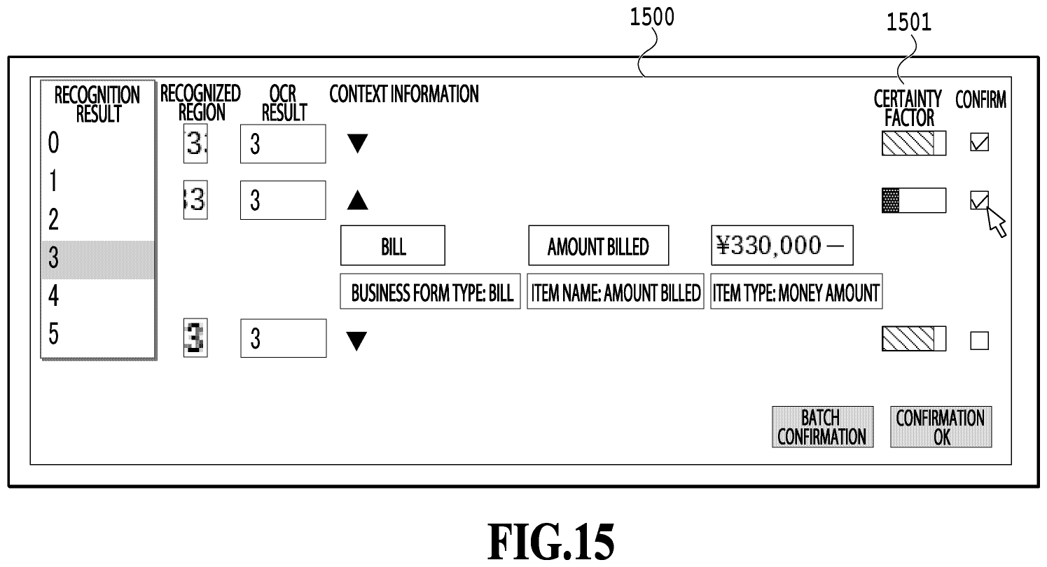

FIG. 14B is a flowchart describing a detailed procedure of the screen generation in the present embodiment. In S1413, in the generation processing of the list display screen of the recognition result, the CPU 221 generates a list display screen of the recognition result including displaying of the certainty factor. FIG. 15 is a diagram illustrating a batch confirmation screen 1500 including the displaying of the certainty factor that is displayed in the present embodiment. In this case, the CPU 221 generates the batch confirmation screen 1500 by adding displaying of a certainty factor 1501 to the list display screen of the recognition result described in the first embodiment. In addition, the certainty factor of each single character is obtained from the context information 710, and a colored bar according to the certainty factor is displayed in an item of the certainty factor. In the present embodiment, the displaying of the certainty factor expresses a level of the certainty factor as the colored bar; however, the certainty factor may be displayed by a number, a character, or another expression method. In a case where the certainty factor is smaller than a threshold, the accordion may be opened in advance to disclose and display the context information.

According to the present embodiment, an item with a high possibility of an incorrect recognition result is displayed prominently to ensure easy recognition by the user, and it is possible to reduce the operation to display the context information of the item by the user. Therefore, the usability during the confirmation operation of the character recognition result is further improved.

### Third Embodiment

In the present embodiment, further improvement in the efficiency of the confirmation operation by switching the screen to be displayed based on an operation history of the user is specifically described with reference to the flowchart. Note that, in the description of the present embodiment, description of a portion in which the configuration and the processing procedure are the same as that in the first and second embodiments is omitted, and only a portion having a different point is described.

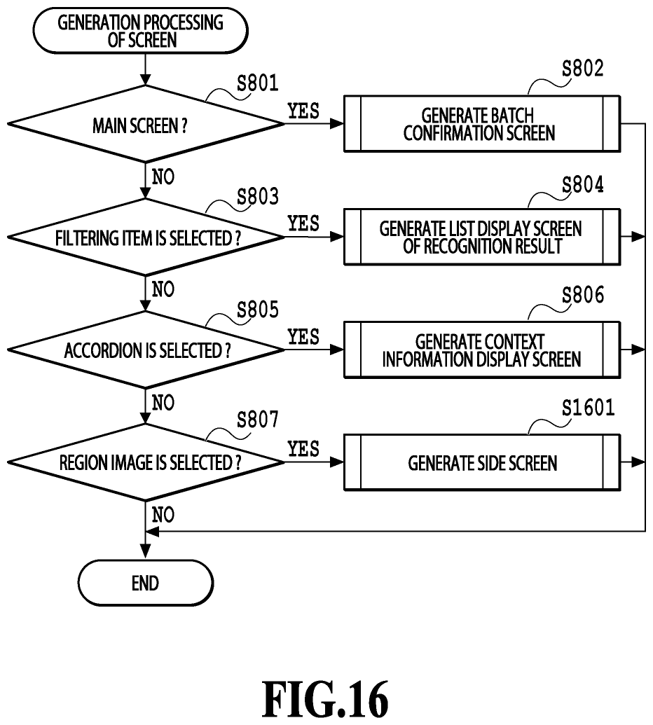

In the present embodiment, the CPU 221 saves in the RAM 223 or the storage unit 228 the operation history of the user while the side screen is being displayed. In this case, the operation history is time in which each side screen is displayed or the number of times the user presses the check while each side screen is being displayed; however, other information may be saved as the operation history. FIG. 16 is a flowchart describing a detailed procedure of the screen generation in the present embodiment. In S1601, the CPU 221 executes the side screen generation processing. In this case, an initial display screen to be generated is switched depending on the operation history. For example, in a case where time in which the similar character list screen is displayed is longer than that of another screen or the number of times of pressing the check is greater than that of another screen, the initial display screen is displayed as the similar character list screen. Additionally, the initial display screen may be switched depending on setting.

According to the present embodiment, it is possible to reduce the operation to display the screen that is used the most for the confirmation or the determination by the user during the confirmation of the character recognition result. Therefore, the usability during the confirmation operation of the character recognition result is further improved.

### Fourth Embodiment

In the present embodiment, further improvement in the efficiency of the confirmation operation by prioritizing displaying of plural images on which the same person writes down a character in a case of displaying the context information and the identical character or the similar character is specifically described with reference to the drawing and the flowchart. Note that, in the description of the present embodiment, description of a portion in which the configuration and the processing procedure are the same as that in the first, second, and third embodiments is omitted, and only a portion having a different point is described.

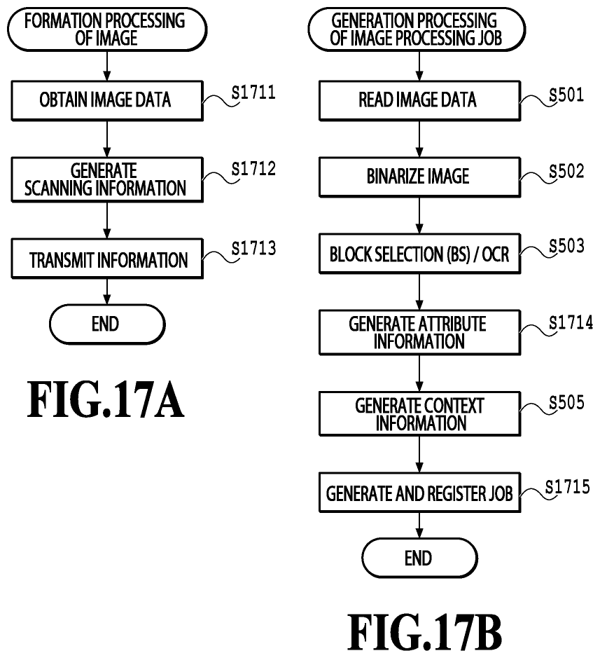

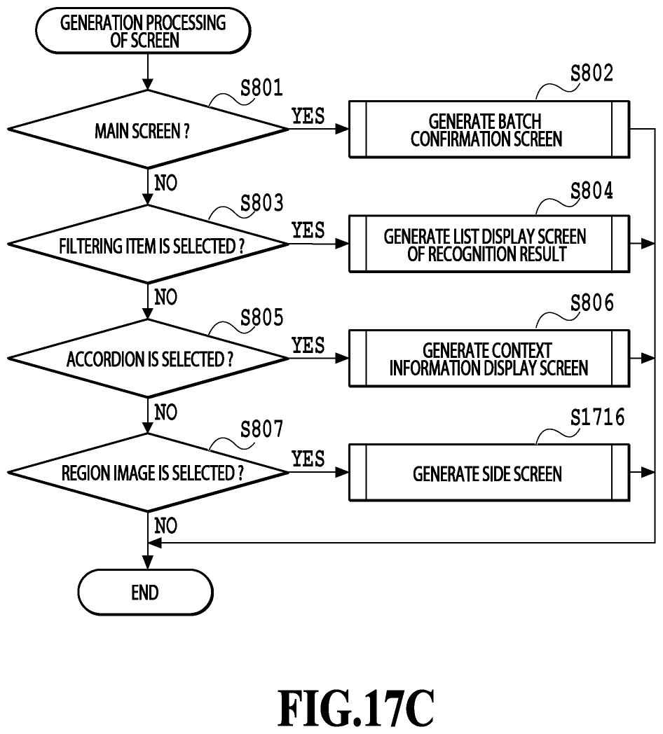

FIG. 17A is a flowchart explaining a detailed procedure of the image generation in the present embodiment. In S1711, the image formation apparatus 101 optically reads the business form of a paper document and generates business form image data, and the processing proceeds to S1712. In S1712, the image formation apparatus 101 obtains information such as the time the image is generated, an account or an identification number of the user who generates the image, and a terminal number of the image formation apparatus 101, and the processing proceeds to S1713. Here, the above-described information is called scanning information. In S1713, the image formation apparatus 101 transmits the generated image and the scanning information to the image processing server 102. The image processing server 102 receives the generated image and the scanning information and saves the generated image and the scanning information in the storage unit 228 in association with each other. In a case where the saving of the generated image and the scanning information is completed, the processing of the flowchart illustrated in FIG. 17A ends.

FIG. 17B is a flowchart explaining a detailed procedure of the image processing job generation in the present embodiment. In S1714, in a case where there is information including the person name and the identification number identifying the person in the extracted character string, the CPU 221 extracts the information in addition to the processing in the first embodiment. In this case, the above-described information is called personal information. For example, in a case where there is the character string “Tarou Yamada”, this character string is extracted as the person name. For example, in a case where there is the character string “personal name code: 000001”, this character string is extracted as a personal name code. In addition, the CPU 221 determines the writer who creates the plural images based on the scanning information and the personal information associated with the image. For example, in a case where the generation time and the terminal number of the image formation apparatus between the images are the same, the CPU 221 determines that the images are the business forms created by the same writer. For example, in a case where there is the same character strings as the person name and the number identifying the person between the images, the CPU 221 determines that the images are the business forms created by the same writer. The method of determining the writer is not limited to the above-described method, and another method may be applied. In addition, in S1715, the CPU 221 registers the information of the writer determined as above with the job list in association with the job. FIG. 17C is a flowchart explaining a detailed procedure of the screen generation in the present embodiment. In S1716 in which the side screen is generated, the CPU 221 generates a screen that displays the plural images created by the same writer.

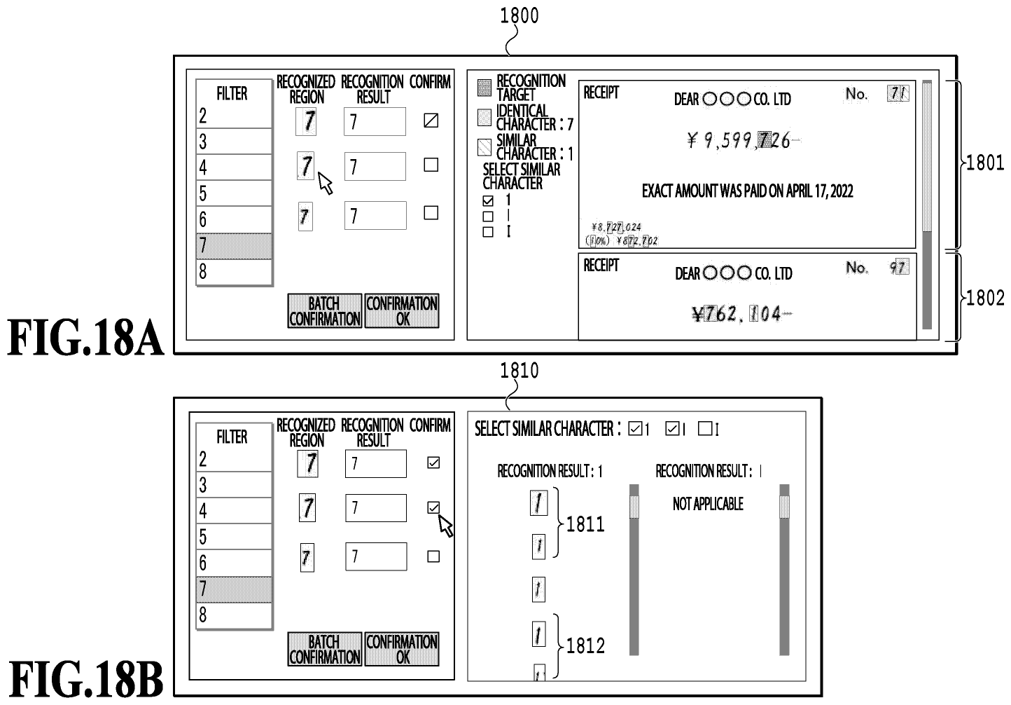

FIG. 18A is an identical/similar character comparison screen to display the plural images that is displayed in the present embodiment. The CPU 221 obtains all the images included in the job list. In addition, the screen is generated by arranging the plural images to be displayed on an image list. Here, the image list is displayed from the top in the order of the image 1801 including the single character region selected by the user, or the image 1802 created by the same writer as that of the above image; otherwise, the image list may be displayed in another order. Then, the highlighting is performed on all the displayed images by the colored frames according to the descriptions on the screen.

FIG. 18B is a similar character list screen to display the plural images that is displayed in the present embodiment. The CPU 221 obtains the character group of the similar character of the single character region selected by the user from all the jobs included in the job list. Then, according to the selection of the similar character by the user, the single character region included in the obtained character group is displayed. Here, the similar character list is displayed from the top in the order of the single character region 1811 of the similar character included in the image in which the single character region selected by the user is included, or the single character region 1812 of the similar character included in the image created by the same writer as that of the above image; otherwise, the single character list may be displayed in another order. Additionally, there may be displayed a line to clearly show boundaries among the single character region 1811 of the similar character included in the image including the single character region selected by the user, the single character region 1812 of the similar character included in the image created by the same writer as that of the above image, and another boundary.

According to the present embodiment, it is possible to prioritize the displaying of the plural images created by the same writer with remarkably similar font or habit of the character shape, to support the determination by the user, and to reduce the time required for the determination. Therefore, the usability during the confirmation operation of the character recognition result is further improved.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-109879, filed Jul. 4, 2023, which is hereby incorporated by reference wherein in its entirety.

What is claimed is:

1. An information processing apparatus comprising:
at least one memory that stores instructions; and
at least one processor that executes the instructions to:
extract a character string and a unit character included in the character string based on a result of character recognition processing on a document image;
generate context information related to the unit character based on the extracted character string and attribute information indicating an attribute of the character string; and
display the extracted unit character and the context information corresponding to the unit character on a UI screen.

2. The information processing apparatus according to claim 1, wherein the at least one processor executes the instructions further to:
obtain a unit character from a character list including the unit character; and
highlight a unit character region and the context information corresponding to the obtained unit character on a UI screen.

3. The information processing apparatus according to claim 1, wherein
the context information includes the attribute information of the character string, information of an image region corresponding to the character string in the document image, attribute information of an adjacent character string having a specific relationship with the character string, information of an image region corresponding to the adjacent character string in the document image, attribute information of a character string indicating a type of the document image, and information of an image region of the character string indicating the type in the document image.

4. The information processing apparatus according to claim 3, wherein
the specific relationship is a relationship between a key and a value.

5. The information processing apparatus according to claim 2, wherein
the UI screen includes a button to switch displaying and hiding the context information of the obtained unit character.

6. The information processing apparatus according to claim 2, wherein the at least one processor executes the instructions further to:
highlight a unit character region corresponding to the obtained unit character and a character string region including the obtained unit character on the UI screen.

7. The information processing apparatus according to claim 6, wherein the at least one processor executes the instructions further to:
highlight the unit character region corresponding to the obtained unit character and the character string region including the obtained unit character on the UI screen in different colors.

8. The information processing apparatus according to claim 2, wherein the at least one processor executes the instructions further to:
display a certainty factor of character recognition of the obtained unit character on the UI screen.

9. The information processing apparatus according to claim 8, wherein the at least one processor executes the instructions further to:
display the context information of the obtained unit character on the UI screen in a case where the certainty factor of character recognition of the obtained unit character is smaller than a threshold.

10. The information processing apparatus according to claim 7, wherein the at least one processor executes the instructions further to:
store a pair of the obtained unit character and a similar character that is similar to the obtained unit character in the memory; and
highlight a character region of the similar character that is similar to the obtained unit character on the UI screen based on data stored in the memory.

11. The information processing apparatus according to claim 10, wherein the at least one processor executes the instructions further to:
highlight the unit character region corresponding to the obtained unit character, the character string region including the obtained unit character, and the character region of the similar character that is similar to the obtained unit character on the UI screen in different colors.

12. The information processing apparatus according to claim 10, wherein
the UI screen further includes a region to receive an input regarding whether to highlight the character region of the similar character, and
the at least one processor executes the instructions further to:
highlight the character region of the similar character on the UI screen in a case where an input indicating highlighting of the character region of the similar character is received.

13. The information processing apparatus according to claim 10, wherein the at least one processor executes the instructions further to:
display a screen showing a recognition result on a main screen of the UI screen and switch and display plural detail screens of the recognition result on a side screen of the UI screen.

14. The information processing apparatus according to claim 13, wherein
the plural detail screens are a context information screen on which the unit character region and the context information corresponding to the obtained unit character are highlighted, a comparison screen on which the obtained unit character and the similar character that is similar to the obtained unit character are compared to each other, and a list screen of the similar character that is similar to the obtained unit character.

15. The information processing apparatus according to claim 14, wherein the at least one processor executes the instructions further to:
store an operation history of a user of the side screen in the memory.

16. The information processing apparatus according to claim 15, wherein
the operation history of the user is time in which each of the plurality of detail screens is displayed or the number of times the user presses a check while each of the plural detail screens is being displayed.

17. The information processing apparatus according to claim 16, wherein the at least one processor executes the instructions further to:
switch and display each of the plurality of detail screens in a descending order of the operation history of the user.

18. The information processing apparatus according to claim 14, wherein the at least one processor executes the instructions further to:
further store a result of the character recognition processing on plural document images;
further extract a person name or an identification number identifying a person from the result of the character recognition processing on the document images; and
display the document images, and the context information screen, the comparison screen and the list screen of the similar character of the plural document images on the plural detail screens based on the extracted person name or identification number identifying the person.

19. A method of controlling an information processing apparatus, the method comprising:
extracting a specific character string having a specific attribute and a unit character included in the specific character string based on a result of character recognition processing on a document image;
generating attribute information indicating the attribute of the extracted specific character string and context information related to the extracted unit character; and
displaying the extracted unit character and the context information corresponding to the unit character on a UI screen.

20. A non-transitory computer readable storage medium storing a program which causes a computer to execute a method of controlling an information processing apparatus, the method comprising:
extracting a specific character string having a specific attribute and a unit character included in the specific character string based on a result of character recognition processing on a document image;
generating attribute information indicating the attribute of the extracted specific character string and context information related to the extracted unit character; and
displaying the extracted unit character and the context information corresponding to the unit character on a UI screen.
